(19) United States
(12) Patent Application Publication
(10) Pub. No.: US 2014/0044010 A1
(43) Pub. Date: Feb. 13, 2014

(54) WIRELESS COMMUNICATION DEVICE, METHOD FOR SETTING COMMUNICATION CONFIGURATION, AND PROGRAM FOR SETTING COMMUNICATION CONFIGURATION

(71) Applicant: SEIKO EPSON CORPORATION, Tokyo (JP)

(72) Inventors: Akira HIROSHIGE, Tokyo (JP); Eiji KAWASE, Tokyo (JP); Takamasa NIWA, Tokyo (JP)

(73) Assignee: SEIKO EPSON CORPORATION, Tokyo (JP)

(21) Appl. No.: 13/962,265

(22) Filed: Aug. 8, 2013

(30) Foreign Application Priority Data
Aug. 8, 2012 (JP) 2012-175759

(51) Int. Cl. H04W 24/02

(52) U.S. Cl. CPC H04W 24/02
USPC 370/254

(57) ABSTRACT

The printer 100 has a first communication section which operates in either one of connection modes including a first mode for operating such that a wireless connection with a single external device is possible and a second mode for operating such that a wireless connection with a plurality of external devices is possible, and a second communication section which connects to the network, in which the connection mode of the first communication section is determined based on connection conditions between the second communication section and the network.

### TECHNICAL FIELD

The present invention relates to a wireless communication device, a method for setting a communication configuration, and a program for setting a communication configuration.

### BACKGROUND ART

As a method for constructing a network, as shown in Patent Document 1, there is known a method using Wi-Fi Direct (registered trademark) which is a standard developed by the Wi-Fi Alliance (hereinafter referred to as a Wi-Fi Direct connection). A wireless communication device which can establish a Wi-Fi Direct connection can conduct communication directly with another wireless communication device which can establish a Wi-Fi Direct connection on a peer-to-peer, that is, one-to-one basis or with a plurality of devices without using an access point. Further, this wireless communication device can conduct communication through a Wi-Fi connection with another wireless communication device which can establish a wireless LAN connection using Wi-Fi (registered trademark) (hereinafter referred to as a Wi-Fi connection) via an access point. Such a Wi-Fi Direct connection can conduct high-speed communication by using the Wi-Fi technology. Further, by using a Wi-Fi Direct connection, an image can be transmitted directly from a camera or a cell phone to a printer for printing, for example.

### PRIOR ART DOCUMENTS

### Patent Documents

[Patent Document 1] Japanese Laid-open Patent Publication No. 2011-166417

### SUMMARY OF THE INVENTION

### Object the Invention is to Achieve

However, when a wireless communication device establishes a Wi-Fi Direct connection, there are cases in which the wireless communication device should wirelessly connect to a single wireless device on a one-to-one basis, or cases in which the wireless communication device should be able to wirelessly connect to a plurality of wireless device on a one-to-N basis depending on the conditions of the connection environment in which the wireless communication device is located. However, partly because it is difficult for a user to appropriately determine whether a wireless connection should be established on a one-to-one basis or on one-to-N basis and conduct a setting operation of the device, it is not preferable in terms of user-friendliness.

### Means of Achieving the Object

The present invention has been made to address at least part of the above-described circumstances, and the present invention can be implemented as the following embodiments or application examples.

### APPLICATION EXAMPLE 1

According to the present application example, a wireless communication device, which connects to a network and conducts wireless communication with an external device, includes a first communication section which has a first mode for operating such that a wireless connection with a single external device is possible and a second mode for operating such that a wireless connection with a plurality of external devices is possible, a second communication section which connects to the network, and a control section which determines the connection mode of the first communication section based on connection information regarding connection conditions between the second communication section and the network, and operates the first communication section in the determined connection mode.

With this configuration, either one of the first mode in which a one-to-one connection is to be used and the second mode in which a one-to-N connection is to be used is determined based on connection conditions between the second communication section and the network. Therefore, a user does not need to select the connection mode, and a preferred connection mode can be determined in accordance with the connection conditions of the network.

### APPLICATION EXAMPLE 2

In the wireless communication device according to the above-described application example, the first communication section may conduct peer-to-peer wireless communication without using an access point, and the second communication section may conduct wireless communication or wired communication via the access point.

### APPLICATION EXAMPLE 3

In the wireless communication device according to the above-described application example, the connection information may include information which shows a content of settings of a connection between the second communication section and the network, and the control section may determine the connection mode of the first communication section based on the information which shows the content of settings.

### APPLICATION EXAMPLE 4

In the wireless communication device according to the above-described application example, the first communication section may determine the first mode as the connection mode in a case where a connection between the second communication section and the network is set, and the first communication section may determine the second mode as the connection mode in a case where a connection between the second communication section and the network is not set.

### APPLICATION EXAMPLE 5

In the wireless communication device according to the above-described application example, the first communication section may determine the first mode as the connection mode in a case where a wireless connection between the second communication section and the network is set, and the first communication section may determine the second mode as the connection mode in a case where a wired connection between the second communication section and the network is set or a connection with the second communication section is not set.

### APPLICATION EXAMPLE 6

According to the present application example, a method for setting a communication configuration of a wireless communication device, which sets a communication configuration to a wireless communication device having a first communication section which operates in either one of connection modes including a first mode for operating such that a wireless connection with a single external device is possible and a second mode for operating such that a wireless connection with a plurality of external devices is possible, and a second communication section which connects to the network, includes an acquiring step of acquiring connection setting information between the second communication section and the network, a determining step of determining either one of the first mode and the second mode as the connection mode based on the acquired connection setting information, and a connecting step of causing the first communication section to establish a wireless connection in the connection mode determined in the determining step.

With this method, either one of the first mode in which a one-to-one connection is to be used or the second mode in which a one-to-N connection is to be used is determined as the connection mode based on connection conditions between the second communication section and the network. Therefore, a user does not need to select the connection mode, and a preferred connection mode can be determined in accordance with the connection conditions of the network.

### APPLICATION EXAMPLE 7

According to the present application example, a program for setting a communication configuration of a wireless communication device, which sets a communication configuration to a wireless communication device having a first communication section which operates in either one of connection modes including a first mode for operating such that a wireless connection with a single external device is possible and a second mode for operating such that a wireless connection with a plurality of external devices is possible, and a second communication section which connects to the network, causes a computer to perform an acquiring function of acquiring connection setting information between the second communication section and the network, a determining function of determining either one of the first mode and the second mode as the connection mode based on the acquired connection setting information, and a connecting step of causing the first communication section to establish a wireless connection in the connection mode determined by the determining function.

With this program, either one of the first mode in which a one-to-one connection is to be used or the second mode in which a one-to-N connection is to be used is determined as the connection mode based on connection conditions between the second communication section and the network. Therefore, a user does not need to select the connection mode, and a preferred connection mode can be determined in accordance with the connection conditions of the network.

### BRIEF DESCRIPTION OF THE DRAWINGS

FIG. 1 is a diagram which shows a printing system according to a first embodiment.

FIG. 2 is a flow chart of a communication configuration setting process in a communication configuration setting program according to the first embodiment.

FIG. 3 is a diagram which shows an example of a mode confirmation screen.

FIG. 4 is a flow chart which shows a Wi-Fi Direct connection process in a case where a first mode is selected.

FIG. 5 is a flow chart which shows a Wi-Fi Direct connection process in a case where a second mode is selected.

FIG. 6 is a flow chart of a communication configuration setting process in a communication configuration setting program according to a second embodiment.

### DETAILED DESCRIPTION OF THE EMBODIMENTS

Hereinafter, the embodiments of the present invention will be explained with reference to the drawings.

### First Embodiment

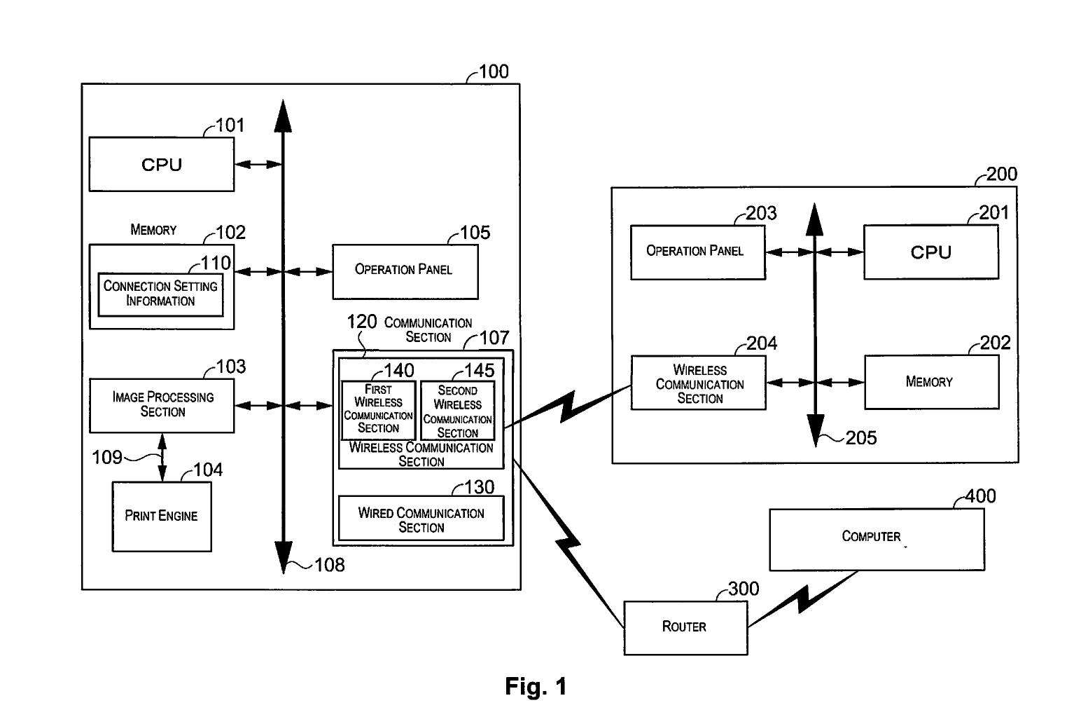

FIG. 1 is a diagram which shows a printing system according to a first embodiment. The printing system has a printer 100, a mobile terminal 200, a router 300, and a computer 400.

The printer 100 serves as a wireless communication device, and can establish a network connection by wireless communication. As for the network connection by wireless communication, an infrastructure mode, that is, a Wi-Fi connection in which communication is conducted via an access point is possible, and a Wi-Fi Direct connection in which peer-to-peer direct communication is conducted without using an access point is also possible. Further, the printer 100 can establish a network connection by wired communication.

The mobile terminal 200 can establish a Wi-Fi Direct connection by wireless communication. Also, the router 300 can conduct wireless communication through a Wi-Fi connection and wired communication through a LAN cable. A so-called personal computer can be used as the computer 400, and the computer 40 is connected with the router 300 so as to be able to communicate through a Wi-Fi connection.

[Printer 100]

The printer 100 has a CPU 101, a memory 102, an image processing section 103, a print engine 104, an operation panel 105, a communication section 107, and buses 108 and 109.

The CPU 101 executes various kinds of programs such as a communication control program, a print control program, a communication configuration setting program, and the like stored in the memory 102, and controls an operation of each device in the printer 100. The memory 102 includes a RAM, a ROM, and a flash memory, and the like. The memory 102 stores various kinds of programs or each data, and stores connection setting information 110 regarding a network connection. For example, the connection setting information 110 includes information regarding a Wi-Fi connection active flag and an access point, SSID information, and the like in settings by a Wi-Fi connection. The connection setting information 110 includes information regarding a wired connection active flag and an IP address, and the like in settings by a wired connection. Here, hardware such as the CPU 101, the memory 102, and the like, and software stored in the memory 102 construct the control section, and each function of the printer 100 is controlled by causing the hardware and the software to cooperate with each other.

For example, a touch panel can be used as the operation panel 105, in which various kinds of messages are displayed and instruction operations from users are received. A Wi-Fi Direct connection start button (not shown in the drawing) is displayed on the operation panel 105 in a predetermined process, and when a user presses the Wi-Fi Direct connection start button, a Wi-Fi Direct connection is activated. As a result of this, the communication configuration setting program is executed, and a Wi-Fi Direct connection process is started.

The communication section 107 has a wireless communication section 120 which communicates through a Wi-Fi connection or a Wi-Fi Direct connection, and a wired communication section 130 which communicates by connecting a LAN cable. A first wireless communication section 140 which wirelessly communicates through a Wi-Fi Direct connection in the wireless communication section 120 corresponds to the first communication section. A second wireless communication section 145 and a wired communication section 130 which establish a Wi-Fi connection in a infrastructure mode in the wireless communication section 120 correspond to the second communication section. Here, the second communication section may be configured to have either one of the second wireless communication section 145 and the wired communication section 130 which establish a Wi-Fi connection.

The communication section 107 according to the first embodiment has two connection modes including a first mode and a second mode as a Wi-Fi Direct connection.

In the first mode, a one-to-one connection for connecting with a single external wireless device is to be used, in which a group owner is determined by negotiation with the external wireless device.

In the first embodiment, when a Wi-Fi Direct connection is established in the first mode with respect to a device which can establish a Wi-Fi Direct connection such as the mobile terminal 200, the communication section 107 disconnects a network connection with the router 300 established in the infrastructure mode. Consequently, while a Wi-Fi Direct connection is established in the first mode, print instructions cannot be issued from the computer 400 to the printer 100.

In the second mode (Autonomous Group Owner mode), a one-to-N (N is a natural number) connection for connecting with a plurality of external wireless devices is to be used, in which the printer 100 itself becomes a group owner without negotiating with the external wireless devices. In the second mode, therefore, even a device which is not compatible with a Wi-Fi Direct connection can establish a connection with the printer 100 through a Wi-Fi connection. However, a device which can establish a Wi-Fi Direct connection and has already become a group owner cannot be connected with the printer 100 additionally. Here, the maximum number of N which can be connected simultaneously is four. However, the present invention is not limited to this.

In the present embodiment, a Wi-Fi Direct connection or a Wi-Fi connection is to be used as the wireless connection. However, the type of the connection is not limited as long as it is a wireless communication device which has a first mode for establishing a wireless peer-to-peer connection directly with a single device and a second mode for establishing a wireless connection with a plurality of devices.

The selection of the first mode and the second mode is determined in the Wi-Fi Direct connection process of the communication configuration setting program executed by the CPU 101 based on the connection conditions of the network by an infrastructure mode, and a Wi-Fi Direct connection is started by the determined mode. Here, the connection conditions of the network are referred from the connection setting information 110 stored in the memory 102, and for example, are determined based on set values of a Wi-Fi connection active flag or a wired connection active flag, and existence or non-existence of settings of SSID information, IP address information or the like.

In the first embodiment, the first mode is selected in a case where a network connection by an infrastructure mode is set with respect to either one of wireless communication and wired communication. Also, the second mode is selected in a case where a network connection by an infrastructure mode is not set with respect to either one of wireless communication and wired communication. However, it may be determined based on actual connection conditions without being limited by determination based on the settings.

In the first mode, the connection type of a Wi-Fi Direct connection is one-to-one. Therefore, time for disconnecting a network connection with the router 300 is shorter than that of a case of one-to-N. Also, since an additional connection of another terminal device is rejected, even in a case where the printer 100 cannot become a group owner as a result of negotiation, no problem is caused by the printer 100 which is not a group owner.

When communication with a device through a Wi-Fi Direct connection is finished, the first mode is automatically deactivated, and print instructions from the computer 400 to the printer 100 become possible. Accordingly, the first mode is suitable for a case where the connection time of a Wi-Fi Direct connection is relatively short and the connection is temporary.

On the other hand, the second mode is suitable for a case where the connection is continuous over a long period of time since the connection is maintained even in a case where the connected device is gone unless it is explicitly deactivated.

The image processing section 103 accepts image data received through the communication section 107, and generates print data by conducting image processing to the image data. The print engine 104 is connected with the image processing section 103 through the bus 109, acquires print data generated by the image processing section 103, and prints an image based on the acquired print data. According to the first embodiment, printing by an inkjet method is to be used in the print engine 104. However, the present invention is not limited to this, and another method such as a laser method can be used.

[Mobile Terminal 200]

As the mobile terminal 200, a high functional cell phone, a multifunctional mobile terminal, or the like is to be used. The mobile terminal 200 has a CPU 201, a memory 202, an operation panel 203, a wireless communication section 204, and a bus 205. The CPU 201 executes various kinds of programs such as a communication control program, and controls each device in the mobile terminal. The memory 202 stores various kinds of programs or each data. The operation panel 203 displays messages and receives instructions from users. The wireless communication section 204 conducts communication through a Wi-Fi Direct connection.

A Wi-Fi Direct connection start button (not shown in the drawing) is displayed on the operation panel 203 by a predetermined operation of a user. When the user presses the Wi-Fi Direct connection start button, transmission and reception of probe signals are started so as to start a connection process with a wireless communication device which can establish a Wi-Fi Direct connection.

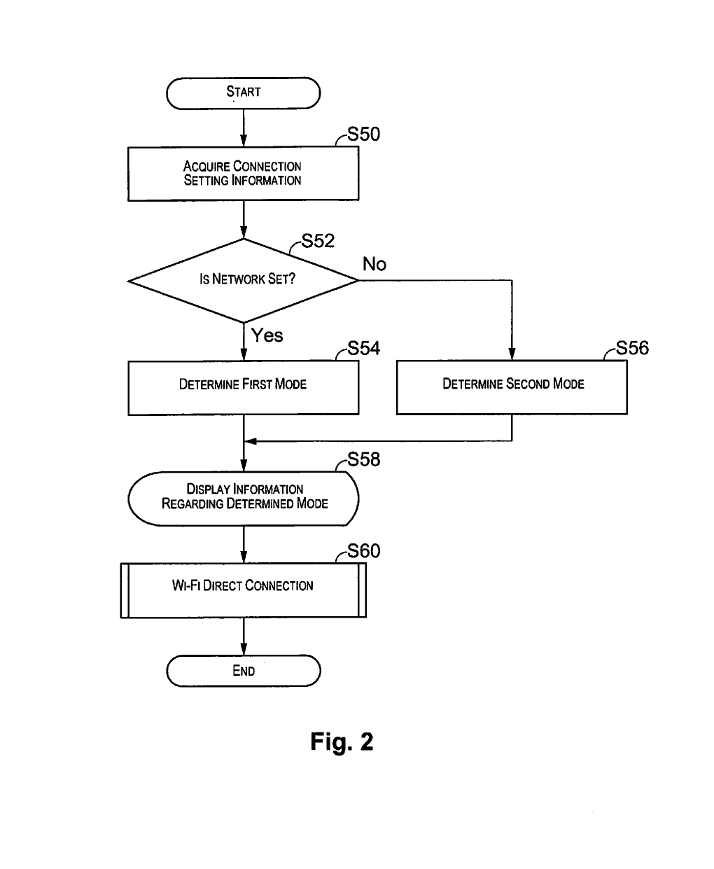

FIG. 2 is a flow chart of the communication configuration setting process in the communication configuration setting program in the printer 100. This process is executed when a user presses the Wi-Fi Direct connection start button displayed on the operation panel 105.

First, the CPU 101 acquires the connection setting information 110 stored in the memory 102 (step S50) <acquiring step>.

Next, the CPU 101 analyzes the connection setting information 110, and judges whether a network connection of an infrastructure mode is set by wireless communication or wired communication (step S52). Here, in a case where it is judged that a network connection is set by either one of wireless communication and wired communication (Yes in step S52), a Wi-Fi Direct connection by the first mode is determined (step S54). On the other hand, in a case where it is judged that a network connection is not set by either one of wireless communication and wired communication (No in step S52), a Wi-Fi Direct connection by the second mode is determined (step S56) <determining step>.

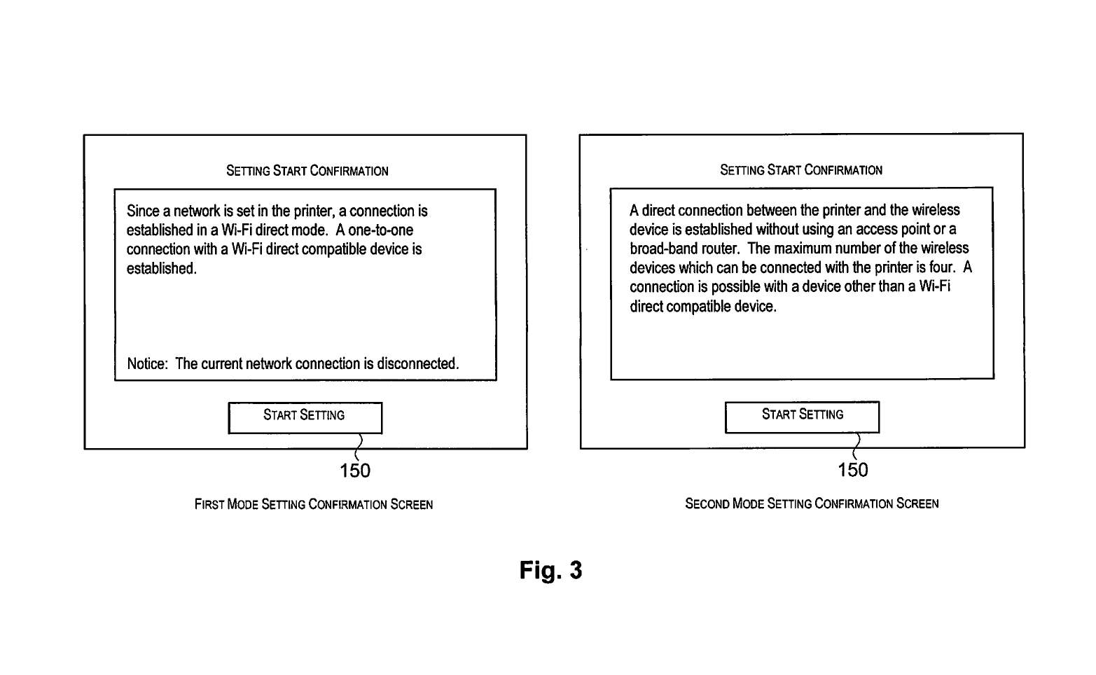

Next, the CPU 101 displays information regarding the determined mode on the operation panel 105 (step S58). Here, FIG. 3 shows an example of a mode confirmation screen displayed on the operation panel 105 in cases of selecting the first mode and the second mode, respectively. A user checks either one of the displayed confirmation screens, and presses a setting start button 150.

Turning back to FIG. 2, when the setting start button 150 is pressed, the CPU 101 starts a Wi-Fi Direct connection in the determined mode (step S60) <connecting step>, and the process of this flow chart is finished.

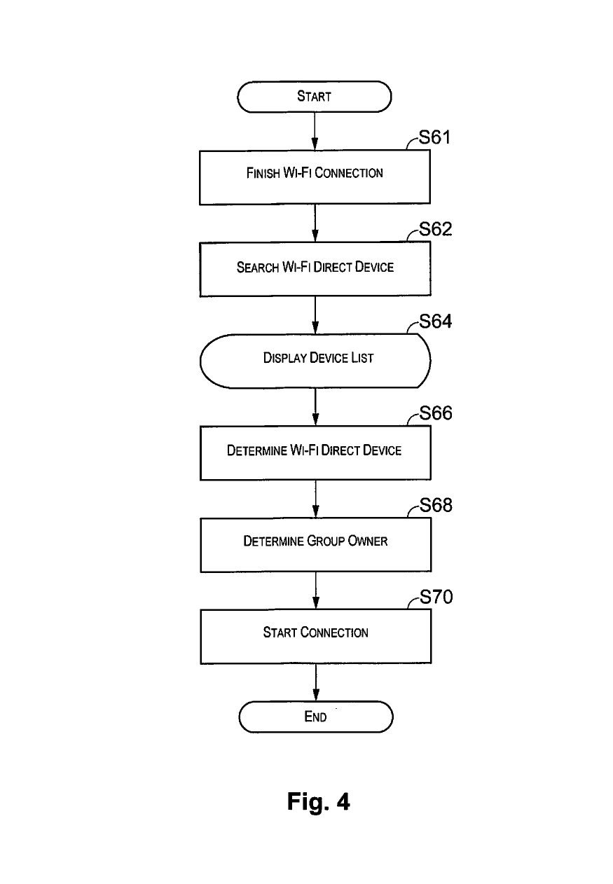

FIG. 4 is a flow chart which shows the details of the Wi-Fi Direct connection process (step S60) in a case where the first mode is selected.

First, the CPU 101 disconnects the Wi-Fi connection with the router 300 which is connected by an infrastructure mode (step S61).

Next, the CPU 101 searches a device which is compatible with a Wi-Fi Direct connection (step S62). More specifically, the CPU 101 issues an instruction to the wireless communication section 120 to transmit a probe request, and the wireless communication section 120 transmits a probe request in accordance with the instruction. When a device which is compatible with a Wi-Fi Direct connection including the mobile terminal 200 receives the probe request, the device transmits a probe response including identification information such as its own MAC address or device name to the printer 100.

Next, the CPU 101 makes a list of devices which are compatible with a Wi-Fi Direct connection (not shown in the drawing) based on the received probe response, and displays the list of devices which has been made on the operation panel 105 (step S64).

Subsequently, the user selects the mobile terminal 200 as a communication destination of a Wi-Fi Direct connection from the list of devices which has been displayed on the operation panel 105. The CPU 101 determines the mobile terminal 200 selected by the user as a device to be connected (step S66).

Next, the CPU 101 determines a group owner by negotiating with the mobile terminal 200 (step S68).

Next, the CPU 101 is connected with the mobile terminal 200, starts communication with the mobile terminal 200 through a Wi-Fi Direct connection (step S70), and finishes the process of this flow chart.

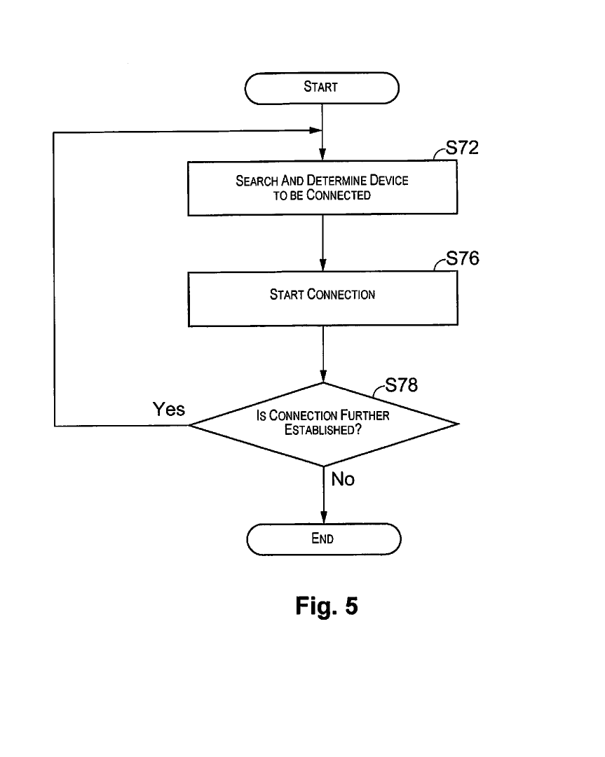

FIG. 5 is a flow chart which shows the details of the Wi-Fi Direct connection process (step S60) in a case where the second mode is selected. According to the first embodiment, in a case of establishing a Wi-Fi Direct connection in the second mode, a setting process by WPS (Wi-Fi Protected Setup) or a manual connection process is to be used.

First, the CPU 101 searches and determines a device to be connected (step S72). In this case, the device may be compatible with a Wi-Fi Direct connection, but does not need to be compatible.

In the setting process by WPS, when a user presses a WPS button (not shown in the drawing) displayed on the mobile terminal 200, a probe request is transmitted from the mobile terminal 200 at a predetermined interval, and the CPU 101 returns a predetermined value (for example, Selected Register is set to OFF) in response to the probe request as a probe response.

Here, by returning a value different from the predetermined value (for example, Selected Register is set to ON) in response to the probe request when the user presses a WPS button (not shown in the drawing) displayed on the operation panel 105, it is notified that a connection with the mobile terminal 200 can be established by WPS.

In the manual connection process, a probe request is transmitted from the mobile terminal 200 at a predetermined interval, and when the second mode is started by operation of the printer 100 on the operation panel 105, a probe response to the probe request is transmitted, and it is notified that a connection can be established.

Next, the CPU 101 starts a connection with a device to be connected, and starts communication (step S76).

In the setting process by WPS, a WPS connection process is started, and the connection process is completed through mutual authentication, determination of an encryption method, and key exchange.

Also, in the manual connection process, when the mobile terminal 200 receives the probe response, an access point list is displayed on the operation panel 203 of the mobile terminal 200, and the user is requested to select an access point to be connected and enter the password. When the user inputs required information and instructs the start of the connection, the connection process is started, and the connection process is completed through mutual authentication, determination of an encryption method, and key exchange.

When the connection is completed by the WPS setting process or the manual connection process, an IP address assignment process between the printer 100 and the mobile terminal 200, or network service using a protocol for printing via a network such as LPR is carried out.

Next, the CPU 101 judges whether a connection with another terminal device is established or not (step S78).

In a case where it is judged that another terminal device is connected (Yes in step S78), a device to be connected through a one-to-N connection (N is a natural number) is determined, and the connection is started.

On the other hand, in a case where it is judged that there is no other terminal device to be connected (No in step S78), the process of this flow chart is finished.

According to the first embodiment described above, since selection of the first mode and the second mode in a Wi-Fi Direct connection is determined based on connection conditions of the network connected in a infrastructure mode, a user does not need to select the mode, and settings can be conducted in an appropriate connection mode in accordance with the connection environment in which the device is located.

For example, in a case of the connection environment in which the printer 100 is connected with a wireless LAN or a wired LAN through the router 300, since the connection environment has already been constructed and thus the printer 100 is usually used through a PC, a mobile terminal, or the like connected via the wireless LAN or the wired LAN, it is considered that communication with the mobile terminal 200 which is newly connected is used on a temporary basis. Therefore, the need of the user can be sufficiently satisfied by causing the printer 100 to operate in the first mode and wirelessly connect with the single mobile terminal 200.

On the other hand, in a case of the connection environment in which the printer 100 is not connected with a wireless LAN or a wired LAN through the router 300, it is considered that a user does not have an access point, for example. Therefore, by causing the printer 100 to operate in the second mode in which a connection with a plurality of mobile terminals can be established, a continuous connection can be established with a plurality of terminals such as a notebook PC and the like in addition to the mobile terminal 200 rather than a temporary connection with the single mobile terminal 200. Consequently, a user can make use of the printer 100 more easily and effectively.

As described above, according to the present embodiment, a user does not need to determine whether the first mode or the second mode should be selected to connect the mobile terminal 200 to the printer 100 taking the connection environment of the printer into consideration, and a wireless connection can be established in an appropriate mode in accordance with the connection environment of the printer 100. Therefore, a wireless communication device excellent in the user-friendliness can be provided.

### Second Embodiment

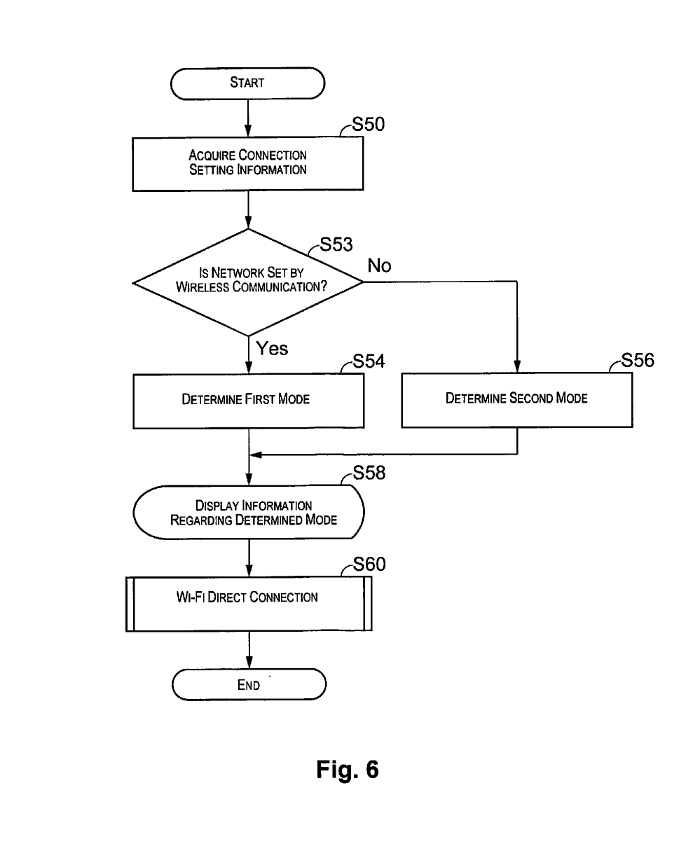

Next, a second embodiment of the present invention will be explained with reference to FIG. 6. In the following explanation, the same elements as the elements which have already been explained are given the same reference symbols, and the explanation thereof will be omitted.

In the first embodiment, the first mode is selected in a case where a network connection by an infrastructure mode is set with either one of wireless communication and wired communication in the Wi-Fi Direct connection process of the communication configuration setting program.

In the second embodiment, the first mode is selected in a case where a network connection by an infrastructure mode is set with wireless communication, and the second mode is selected in a case where a network connection by an infrastructure mode is set with wired communication or a network connection by an infrastructure mode is not set with either one of wireless communication and wired communication.

FIG. 6 is a flow chart of the communication configuration setting process in the printer 100. In step S53, the CPU 101 analyzes the connection setting information 110, and judges whether or not a network connection of an infrastructure mode is set by wireless communication. Here, in a case where it is judged that a network connection is set by wireless communication (Yes in step S53), a Wi-Fi Direct connection in the first mode is determined (step S54). On the other hand, in a case where it is judged that a network connection is set by wired communication or a network connection is not set (No in step S53), a Wi-Fi Direct connection in the second mode is determined (step S56).

Here, in a case where the printer 100 is connected with a wired LAN, it is considered that the connection environment to the wired LAN has been constructed but the connection environment to the wireless LAN has not been constructed. In the second embodiment, by causing the printer 100 to operate in the second mode in such a case, the wireless connection environment can be constructed such that a plurality of wireless terminals such as a notebook PC and the like in addition to the mobile terminal 200 can be continuously and wirelessly connected with the printer 100 while keeping the connection environment to the wired LAN which already exists.

The embodiments of the present invention were explained with reference to the drawings. However, the detailed configurations are not limited to these embodiments, and the present invention includes design modifications as long as they do not depart from the subject matter of the present invention. For example, the wireless communication device is not limited to the printer 100, and various information processing devices such as a multifunction machine, an image projecting device, an image scanning device, and the like are conceivable.

Also, a device for implementing the above-described technique includes various kinds of embodiments. There are cases in which it is achieved by a single device, and there are cases in which it is achieved by combining a plurality of devices.

The entire disclosure of Japanese Patent Application No. 2012-175759, filed Aug. 8, 2012 is expressly incorporated by reference herein.

1. A wireless communication device, which connects to a network and conducts wireless communication with an external device, comprising:
a first communication section which has a first mode for operating such that a wireless connection with a single external device is possible and a second mode for operating such that a wireless connection with a plurality of external devices is possible;
a second communication section which connects to the network; and
a control section which determines the connection mode of the first communication section based on connection information regarding connection conditions between the second communication section and the network, and operates the first communication section in the determined connection mode.

2. The wireless communication device according to claim 1, wherein the first communication section conducts peer-to-peer wireless communication without using an access point, and the second communication section conducts wireless communication or wired communication via the access point.

3. The wireless communication device according to claim 1, wherein the connection information includes information which shows a content of settings of a connection between the second communication section and the network, and the control section determines the connection mode of the first communication section based on the information which shows the content of settings.

4. The wireless communication device according to claim 3, wherein the first communication section determines the first mode as the connection mode in a case where a connection between the second communication section and the network is set, and the first communication section determines the second mode as the connection mode in a case where a connection between the second communication section and the network is not set.

5. The wireless communication device according to claim 3, wherein the first communication section determines the first mode as the connection mode in a case where a wireless connection between the second communication section and the network is set, and the first communication section determines the second mode as the connection mode in a case where a wired connection between the second communication section and the network is set or a connection with the second communication section is not set.

6. A method for setting a communication configuration of a wireless communication device, which sets a communication configuration to a wireless communication device having a first communication section which operates in either one of connection modes including a first mode for operating such that a wireless connection with a single external device is possible and a second mode for operating such that a wireless connection with a plurality of external devices is possible, and a second communication section which connects to the network, comprising:
an acquiring step of acquiring connection setting information between the second communication section and the network;
a determining step of determining either one of the first mode and the second mode as the connection mode based on the acquired connection setting information; and
a connecting step of causing the first communication section to establish a wireless connection in the connection mode determined in the determining step

7. A computer readable recording medium storing a program for setting a communication configuration of a wireless communication device, which sets a communication configuration to a wireless communication device having a first communication section which operates in either one of connection modes including a first mode for operating such that a wireless connection with a single external device is possible and a second mode for operating such that a wireless connection with a plurality of external devices is possible, and a second communication section which connects to the network, causes a computer to perform:
an acquiring function of acquiring connection setting information between the second communication section and the network;
a determining function of determining either one of the first mode and the second mode as the connection mode based on the acquired connection setting information; and
a connecting step of causing the first communication section to establish a wireless connection in the connection mode determined by the determining function.
